(19) United States
(12) Patent Application Publication
(10) Pub. No.: US 2013/0099605 A1
(43) Pub. Date: Apr. 25, 2013

(54) BOBBIN WITH TERMINAL AND MOTOR

(71) Applicant: NIDEC SANKYO CORPORATION, Nagano (JP)

(72) Inventor: Ikuo AGEMATSU, Nagano (JP)

(73) Assignee: NIDEC SANKYO CORPORATION, Nagano (JP)

(21) Appl. No.: 13/625,990

(22) Filed: Sep. 25, 2012

(30) Foreign Application Priority Data
Oct. 25, 2011 (JP) 2011-233504

(51) Int. Cl. H02K 11/00; H02K 1/04

(52) U.S. Cl. 310/43; 310/71

(57) ABSTRACT

A bobbin with a terminal may include a winding part having a tube shape around which a conducting wire is wound, a terminal block which is formed on one end side in an axial direction of the winding part, and a plurality of terminals which is protruded from the terminal block in a direction substantially perpendicular to the axial direction of the winding part. A tip end of the terminal is formed with an inclined face which is inclined with respect to the axial direction of the winding part, and the inclined face is inclined so that the conducting wire abutted with the tip end of the terminal is slid down only toward the winding part when the conducting wire is to be wound around the winding part. The bobbin with a terminal may be utilized in a motor provided with a drive coil which is structured of the conducting wire.

### CROSS REFERENCE TO RELATED APPLICATION

The present invention claims priority under 35 U.S.C. §119 to Japanese Application No. 2011-233504 filed Oct. 25, 2011, the entire content of which is incorporated herein by reference.

### FIELD OF THE INVENTION

At least an embodiment of the present invention may relate to a bobbin with a terminal which is used in a motor and relate to a motor provided with the bobbin with a terminal.

### BACKGROUND

Conventionally, a stepping motor has been known which includes a drive magnet which is fixed to a rotation shaft, pole teeth facing an outer peripheral face of the drive magnet, and a drive coil which is disposed on an outer peripheral side of the pole teeth (see, for example, Japanese Patent Laid-Open No. 2008-263691). In the stepping motor described in the Patent Literature, a conducting wire is wound around a bobbin made of insulating material to structure the drive coil. The bobbin which is used in the stepping motor is, like a bobbin 101 shown in FIGS. 6(A) and 6(B), provided with a cylindrical tube part 101a formed in a cylindrical tube shape with flanges, a terminal block 101b which is formed in a flat rectangular solid shape, and two terminals 101c formed in a rectangular prismatic shape.

The terminal block 101b is formed so as to extend from an outer peripheral end of a flange part 101d structuring one end in an axial direction of the cylindrical tube part 101a in a direction perpendicular to the axial direction (upper direction in FIGS. 6(A) and 6(B)). Further, the terminal block 101b is formed so as to protrude to an outer side in the axial direction (rear side in FIGS. 6(A) and 6(B)) with respect to the flange part 101d. In FIGS. 6(A) and 6(B), terminals 101c are formed so as to stand up from an upper face of the terminal block 101b in the direction perpendicular to the axial direction of the cylindrical tube part 101a.

A conducting wire 102 is commonly wound around the bobbin 101 in a following procedure. In other words, first, one end of the conducting wire 102 is wound around one of the terminals 101c and fixed to the terminal 101c. After that, the conducting wire 102 is wound around an outer peripheral face of the cylindrical tube part 101a. After that, the other end of the conducting wire 102 is wound around the other of the terminals 101c and fixed to the terminal 101c and a wire beyond the fixed conducting wire 102 is cut off. In this manner, the conducting wire 102 is wound around the bobbin 101. Further, a winding work of the conducting wire 102 around the bobbin 101 is commonly performed by using a coil winding machine automatically. In FIGS. 6(A) and 6(B), both end sides of the conducting wire 102 which is wound around and fixed to the terminals 101c are not shown.

Recently, in the market of a small stepping motor, requirement of further downsizing for a stepping motor is increased. In order to reduce the size in the axial direction of the stepping motor, the present inventor has considered and examined that it is effective that a distance “L10” in the axial direction between the cylindrical tube part 101a and the terminal 101c in the conventional bobbin 101 shown in FIGS. 6(A) and 6(B) is shortened as shown in FIG. 7. However, the present inventor has found that, in a case that the distance “L10” between the cylindrical tube part 101a and the terminal 101c in the axial direction is simply shortened, the conducting wire 102 may be caught by an end face of the terminal 101c when the conducting wire 102 is to be wound around the bobbin 101. Specifically, the problem may be occurred as described below with reference to FIGS. 6(A) and 6(B). In other words, when the conducting wire 102 is to be wound around the cylindrical tube part 101a, in a case that the distance “L10” between the cylindrical tube part 101a and the terminal 101c in the axial direction is shortened as shown in FIG. 7, the conducting wire 102 may be caught by a tip end face (upper end face in FIGS. 6(A) and 6(B)) of one of the terminals 101c.

### SUMMARY

In view of the problem described above, at least an embodiment of the present invention may advantageously provide a bobbin with a terminal which is capable of preventing a conducting wire from being caught by a terminal at the time of winding of the conducting wire even when a distance between the winding part around which the conducting wire is wound and the terminal is small. Further, at least an embodiment of the present invention may advantageously provide a motor which includes the bobbin with a terminal.

According to at least an embodiment of the present invention, there may be provided a bobbin with a terminal including a winding part having a tube shape around which a conducting wire is wound on its outer peripheral side, a terminal block which is formed on one end side in an axial direction of the winding part, and a plurality of terminals which is protruded from the terminal block in a direction substantially perpendicular to the axial direction of the winding part. A tip end of the terminal is formed with an inclined face which is inclined with respect to the axial direction of the winding part, and the inclined face is inclined so that the conducting wire abutted with the tip end of the terminal is slid down only toward the winding part when the conducting wire is to be wound around the winding part.

In the bobbin with a terminal in accordance with at least an embodiment of the present invention, a tip end of the terminal is formed with an inclined face which is inclined with respect to an axial direction of the winding part and the inclined face is inclined so that the conducting wire abutted with the tip end of the terminal is slid down only toward the winding part at the time of winding of the conducting wire around the winding part. In other words, at least an embodiment of the present invention, although a tip end of the terminal is formed with an inclined face which is inclined so that the conducting wire abutted with the tip end of the terminal is slid down only toward the winding part at the time of winding of the conducting wire around the winding part, an inclined face is not formed which is inclined so that the conducting wire abutted with the tip end of the terminal is slid down toward an opposite side to the winding part at the time of winding of the conducting wire around the winding part. Therefore, a distance between the terminal and the winding part can be shortened and, even when a conducting wire is abutted with the tip end of the terminal at the time of winding of the conducting wire around the winding part, the conducting wire is easily slid down toward the winding part. Accordingly, according to at least an embodiment of the present invention, even when a distance between the winding part and the terminal is small, the conducting wire is prevented from being caught by the terminal at the time of winding of the conducting wire.

In this case, the “inclined face” in accordance with the present invention does not include a minute convex curved face (for example, a convex curved face whose radius of curvature is about 0.05 mm-0.1 mm) which is inevitably formed at the time of a die working for resin molding at an edge of a tip end of the terminal. In other words, in a case that the terminal is formed by resin molding, a minute convex curved face is inevitably formed at an edge of the tip end of the terminal at the time of a die working and the convex curved face is formed to be inclined so that the conducting wire abutted with the convex curved face is slid down toward an opposite side to the winding part at the time of winding of the conducting wire around the winding part. This embodiment is also included in the technical scope of the present invention.

In at least an embodiment of the present invention, the inclined face is inclined so as to approach the winding part toward the other end side in the axial direction of the winding part. Further, in at least an embodiment of the present invention, the tip end of the terminal is structured of only the inclined face. In these cases, a cross-sectional shape of the terminal in a direction perpendicular to a protruding direction of the terminal may be a polygonal shape or a circular shape and, in general, a cross-sectional shape of the terminal in a direction perpendicular to a protruding direction of the terminal may be a substantially rectangular shape. As described above, in a case that the tip end of the terminal is structured of only the inclined face, when the conducting wire is abutted with the tip end of the terminal at the time of winding of the conducting wire around the winding part, the conducting wire is always abutted with the inclined face. Therefore, even when the conducting wire is abutted with the tip end of the terminal at the time of winding of the conducting wire around the winding part, the conducting wire is further easily slid down to the winding part along the inclined face. Accordingly, the conducting wire is effectively prevented from being caught by the terminal at the time of winding of the conducting wire. Specifically, it is preferable that an inclination angle of the inclined face is set to be at an angle of not more than 45° with respect to the axial direction of the winding part.

In at least an embodiment of the present invention, the inclined face is formed in a flat face. Alternatively, in at least an embodiment of the present invention, the inclined face is formed in a curved face. In these cases, the conducting wire which is abutted with the inclined face at the time of winding of the conducting wire around the winding part is easily slid along the inclined face and, as a result, the conducting wire abutted with the inclined face is further easily slid down to the winding part. In a case that the inclined face is formed in a flat shape, the inclined face is easily formed in comparison with a case that the inclined face is formed in a curved face.

In at least an embodiment of the present invention, the terminal is formed of resin. According to this structure, the terminal can be integrally formed with the winding part and the terminal block which are commonly formed of resin. Therefore, the terminal is easily formed. Specifically, it may be structured that the winding part, circular ring-shaped flange parts which are formed at both ends in the axial direction of the winding part, the terminal block which is formed on one end side in the axial direction of the flange part, and the plurality of the terminals which are protruded from the terminal block are integrally formed with each other by resin molding.

In at least an embodiment of the present invention, a distance between a side face on a winding part side of the terminal and a side face on a winding part side of the terminal block is set to be a half or less of a dimension of the terminal in the axial direction of the winding part. Further, in at least an embodiment of the present invention, a totaled dimension of the terminal block which is protruded to both sides with respect to the terminal in the axial direction of the winding part is set to be not more than a dimension of the terminal in the axial direction of the winding part. Further, in at least an embodiment of the present invention, a distance between a side face of the terminal on an opposite side to the winding part and a side face of the terminal block on an opposite side to the winding part is set to be a half or less of a dimension in the axial direction of the terminal. According to at least an embodiment of the present invention, even when the conducting wire is abutted with the tip end of the terminal at the time of winding of the conducting wire around the winding part, the conducting wire is slid down toward the winding part. Therefore, even when a distance between the terminal and the winding part is shortened and, even when a dimension of the terminal block in the axial direction of the winding part is set to be small, the conducting wire is prevented from being caught by the terminal at the time of winding of the conducting wire.

In at least an embodiment of the present invention, the terminal block is formed with a terminal block side inclined face which is inclined so that the conducting wire abutted with the terminal block is slid down only toward the winding part when the conducting wire is to be wound around the winding part. According to this structure, even when the conducting wire is abutted with the terminal block at the time of winding of the conducting wire around the winding part, the conducting wire is easily slid down toward the winding part. Therefore, the conducting wire is prevented from being caught by the terminal block at the time of winding of the conducting wire.

In at least an embodiment of the present invention, the terminal block is provided with a first side face which is disposed on a winding part side and a second side face on which a base end of the terminal is disposed, the terminal block side inclined face is formed at a boundary between the first side face and the second side face, and the terminal block side inclined face is inclined with respect to the axial direction of the winding part so as to approach the winding part toward the other end side in the axial direction of the winding part. When the conducting wire is to be wound around the winding part, the conducting wire is most likely to be abutted with a boundary between the first side face and the second side face. Therefore, according to the above-mentioned structure, the conducting wire is effectively prevented from being caught by the terminal block at the time of winding of the conducting wire. In this case, it is preferable that a boundary line between the terminal block side inclined face and the second side face is located on an opposite side to the winding part with respect to a side face on a winding part side of the terminal.

In at least an embodiment of the present invention, the terminal block is provided with a first side face which is disposed on a winding part side and a second side face on which a base end of the terminal is disposed, the second side face is structured of the terminal block side inclined face and is inclined with respect to the axial direction of the winding part so as to approach the winding part toward the other end side in the axial direction of the winding part. According to this structure, when the conducting wire is abutted with the second side face at the time of winding of the conducting wire, the conducting wire is always abutted with the terminal block side inclined face. Therefore, even when the conducting wire is abutted with the second side face at the time of winding of the conducting wire, the conducting wire is further easily slid down to the winding part along the second side face which is the terminal block side inclined face. Accordingly, the conducting wire is effectively prevented from being caught by the terminal block at the time of winding of the conducting wire.

In at least an embodiment of the present invention, the terminal block is provided with a first side face in a flat face which is disposed on a winding part side, the terminal is provided with a third side face in a flat face which is disposed on the winding part side, and the first side face and the third side face are disposed on the same flat face as each other. According to this structure, in comparison with a case that the third side face is displaced from the first side face to an opposite side to the winding part, the size in the axial direction of the bobbin with a terminal is reduced. Further, according to this structure, the conducting wire is effectively prevented from being caught by the terminal block at the time of winding of the conducting wire.

The bobbin with a terminal in accordance with at least an embodiment of the present invention may be utilized in a motor provided with a drive coil which is structured of a conducting wire that is wound around the winding part and a drive magnet which is disposed on an inner peripheral side of the bobbin with a terminal. In this motor, even when a distance between the winding part and the terminal is small, the conducting wire is prevented from being caught by the terminal at the time of winding of the conducting wire. Therefore, the size in the axial direction of the motor can be reduced while preventing the conducting wire from being caught by the terminal at the time of winding of the conducting wire.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a partially sectional view showing a motor in accordance with an embodiment of the present invention.

FIGS. 2(A) and 2(B) are views showing a bobbin in FIG. 1. FIG. 2(A) is a perspective view showing the bobbin and FIG. 2(B) is its side view.

FIGS. 3(A), 3(B) and 3(C) are explanatory side views showing shapes of terminals in accordance with other embodiments of the present invention.

FIGS. 4(A), 4(B) and 4(C) are explanatory views showing a shape of a terminal in accordance with another embodiment of the present invention. FIG. 4(A) is a perspective view showing the shape of the terminal, FIG. 4(B) is its plan view, and FIG. 4(C) is its side view.

FIGS. 5(A) through 5(F) are explanatory perspective views showing shapes of terminal blocks in accordance with other embodiments of the present invention.

FIGS. 6(A) and 6(B) are views for explaining a structure of a conventional bobbin. FIG. 6(A) is its perspective view and FIG. 6(B) is its front view. (The conducting wire 102 is added for explaining the problem that the present inventor has pointed out.)

FIG. 7 is a side view showing a structure of a bobbin as an example which is considered by the present inventor.

### DETAILED DESCRIPTION OF THE PREFERRED EMBODIMENTS

An embodiment of the present invention will be described below with reference to the accompanying drawings.

(Entire Structure of Motor)

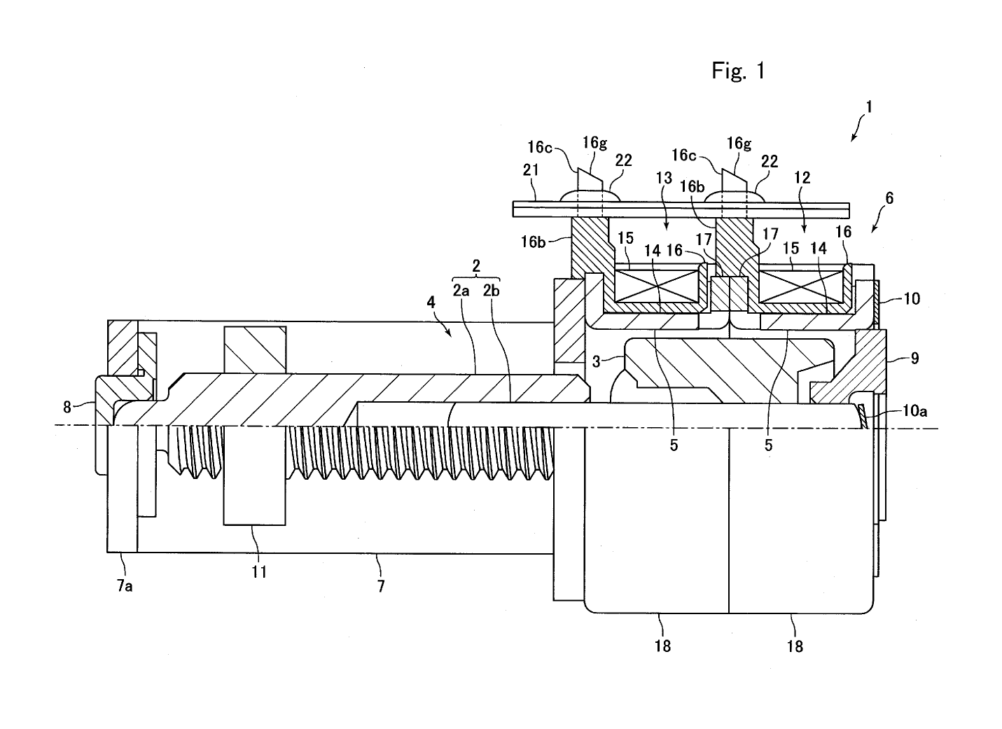

FIG. 1 is a partially sectional view showing a motor 1 in accordance with an embodiment of the present invention.

The motor 1 in this embodiment is a so-called PM type stepping motor. The motor 1 includes a rotor 4 having a rotation shaft 2 and a drive magnet 3, a stator 6 having pole teeth 5 which are oppositely disposed on an outer side in a radial direction of the drive magnet 3, and a frame 7 which is attached to the stator 6 on an output side of the rotation shaft 2. Further, the motor 1 includes a bearing 8 which supports an end part on an output side of the rotation shaft 2, a bearing 9 which supports an end part on an opposite-to-output side of the rotation shaft 2, and a plate spring 10 as an urging member which urges the rotation shaft 2 to the output side.

The rotation shaft 2 is structured of a lead screw 2a which is an output side portion of the rotation shaft 2, and a long and thin shaft part 2b in a cylindrical shape which is an opposite-to-output side portion of the rotation shaft 2. A male screw is formed on an outer peripheral face of the lead screw 2a and a nut member 11 is engaged with the lead screw 2a. The drive magnet 3 is a permanent magnet which is formed in a substantially cylindrical tube shape. The drive magnet 3 is fixed to an outer peripheral face of the shaft part 2b of the rotation shaft 2 which is disposed in an inside of the stator 6. An “N”-pole and an “S”-pole are alternately magnetized on an outer peripheral face of the drive magnet 3 along a circumferential direction.

The stator 6 includes a first stator assembly 12 and a second stator assembly 13 which are disposed so as to be superposed on each other in an axial direction. The first stator assembly 12 includes an outer stator core 14, a bobbin 16 as a bobbin with a terminal around which a drive coil 15 is wound, an inner stator core 17 which sandwiches the bobbin 16 together with the outer stator core 14, and a case 18. The second stator assembly 13 includes, similarly to the first stator assembly 12, an outer stator core 14, a bobbin 16 as a bobbin with a terminal around which a drive coil 15 is wound, an inner stator core 17, and a case 18.

The bobbin 16 is formed in a substantially cylindrical tube shape with flanges as a whole. A conducting wire is wound around an outer peripheral face of the bobbin 16 and the drive coil 15 is formed by winding the conducting wire around the outer peripheral face of the bobbin 16 in a substantially cylindrical tube shape. A plurality of pole teeth 5 which are formed in each of the outer stator core 14 and the inner stator core 17 are disposed on an inner peripheral side of the bobbin 16 so as to be adjacent to each other in a circumferential direction. The drive magnet 3 is disposed on an inner peripheral side of the pole teeth 5. A detailed structure of the bobbin 16 will be described below.

The case 18 covers outer peripheral sides of the outer stator core 14, the drive coil 15, the bobbin 16 and the inner stator core 17. The case 18 is, for example, integrally formed with the outer stator core 14 so as to be connected with an outer circumferential edge of the outer stator core 14. The bearing 8 is fixed to a side face part 7a of the frame 7 which is formed of a metal thin plate. The bearing 9 is fixed on an opposite-to-output side of the stator 6. The plate spring 10 is attached to the opposite-to-output side of the stator 6. A center part of the plate spring 10 is formed with a spring part 10a which is abutted with an opposite-to-output side end of the rotation shaft 2 to urge the rotation shaft 2 to the output side.

(Structure of Bobbin)

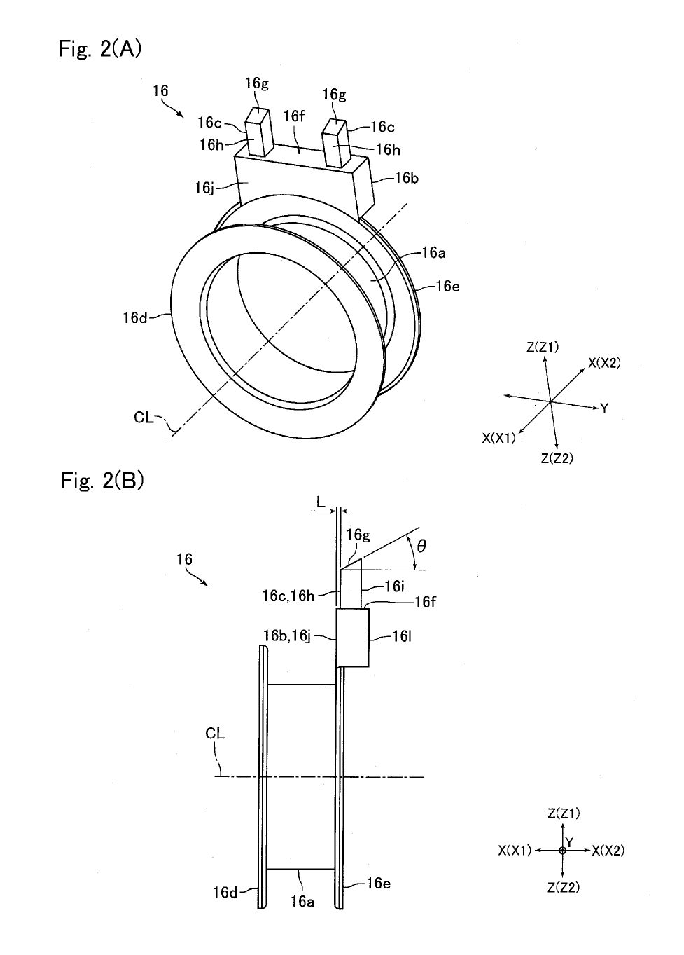

FIGS. 2(A) and 2(B) are views showing the bobbin 16 in FIG. 1. FIG. 2(A) is a perspective view showing the bobbin 16 and FIG. 2(B) is its side view.

The bobbin 16 is formed of resin having an insulation property. Further, the bobbin 16 is provides with a winding part 16a around which a conducting wire structuring the drive coil 15 is wound, a terminal block 16b which is formed on one end side of the winding part 16a in a direction of a center axis “CL” (axial direction) of the winding part 16a, and two terminals 16c which are protruded from the terminal block 16b. The winding part 16a, the terminal block 16b and the terminals 16c are integrally formed with each other, and the winding part 16a, the terminal block 16b and the terminals 16c are integrally formed of resin. Further, the bobbin 16 in this embodiment is formed by resin molding with the use of a die.

In the following descriptions, three directions perpendicular to each other are referred to as an “X” direction, a “Y” direction and a “Z” direction, and the “X” direction is set to be a “front and rear direction”, the “Y” direction is set to be a “right and left direction”, and the “Z” direction is set to be an “upper and lower direction”. Further, an “X1” direction side is set to be a “front” side, an “X2” direction side is set to be a “rear” side, the “Z1” direction side is set to be an “upper” side, and the “Z2” direction side is set to be a “lower part” side. In addition, a plane which is formed by the “X” direction and the “Y” direction is set to be an “XY” plane, the plane which is formed by the “Y” direction and the “Z” direction is set to be a “YZ” plane, and a plane which is formed by the “Z” direction and the “X” direction is set to be a “ZX” plane. In this embodiment, a direction of the center axis “CL” (axial direction) of the winding part 16a is coincided with the front and rear direction.

The winding part 16a is formed in a cylindrical tube shape with a flange which is provided with circular ring-shaped flange parts 16d and 16e at both ends in the front and rear direction, i.e., in the axial direction of the center axis “CL” of the winding part 16a. The terminal block 16b is formed in a flat rectangular solid shape in the front and rear direction. Further, a width in the right and left direction of the terminal block 16b is wider than a width in the upper and lower direction. The terminal block 16b is formed so as to stand up in an upper direction from an upper end side of the flange part 16e which structures a rear end part of the winding part 16a. In this case, a front side face 16j which is a side face on the winding part 16a side of the terminal block 16b may be structured to be the same face as a side face on the winding part 16a side of the flange part 16e (see FIG. 2(B)). Alternatively, the front side face 16j of the terminal block 16b may be stood up from a position slightly retreated from the side face on the winding part 16a side of the flange part 16e (see FIG. 1). Further, the terminal block 16b is structured so as to protrude to a rear side with respect to the rear end face of the winding part 16a (in other words, the rear face of the flange part 16e). In this case, in order to reduce the dimension of the bobbin 16 in the axial direction of the center axis “CL”, a protruding amount of the rear side face 161 of the terminal block 16b with respect to the terminal 16c is set to become as small as possible. In other words, a distance between the rear side face 16i of the terminal 16c and the rear side face 161 of the terminal block 16b is set to be a half or less of a dimension of the terminal 16c in the axial direction of the center axis “CL”. Further, a dimension of the terminal block 16b which is protruded from both sides of the terminal 16c in the axial direction of the center axis “CL” is set to be not more than a dimension in the axial direction of the terminal 16c. Both side faces in the front and rear direction of the terminal block 16b are substantially parallel to the “YZ” plane, both side faces in the right and left direction of the terminal block 16b are substantially parallel to the “ZX” plane, and both side faces in the upper and lower direction of the terminal block 16b are substantially parallel to the “XY” plane.

The terminal 16c is formed in a substantially rectangular prismatic shape. Further, two terminals 16c are formed so as to stand up to an upper side from an upper side face 16f of the terminal block 16b in a separated state from each other in the right and left direction with a predetermined distance. A lower end (base end) of the terminal 16c is connected with an upper side face 16f of the terminal block 16b. In other words, two terminals 16c are disposed substantially parallel to each other and are protruded in the upper direction from the upper side face 16f. Both side faces of the terminal 16c in the front and rear direction (both side faces in the center axis “CL” direction) are substantially parallel to the “YZ” plane and both side faces of the terminal 16c in the right and left direction are substantially parallel to the “ZX” plane.

On the other hand, an upper side face which structures a tip end of the terminal 16c is formed in an inclined face 16g which is inclined in the front and rear direction (in other words, in the axial direction of the winding part 16a). In other words, the tip end of the terminal 16c is formed with one inclined face 16g which is inclined toward the winding part 16a in the front and rear direction, and the tip end of the terminal 16c is formed with no flat face which is parallel to the center axis “CL” direction and the tip end of the terminal 16c is structured of only the inclined face 16g. In other words, the tip end of the terminal 16c is formed with the inclined face 16g from the rear side face 16i of the terminal 16c to the front side face 16h of the terminal 16c. The inclined face 16g is formed in a flat face. Further, the inclined face 16g is inclined in the lower direction toward the front side where the winding part 16a is formed. In other words, the inclined face 16g is inclined toward the front side so as to approach the winding part 16a. The inclination angle “θ” of the inclined face 16g with respect to the front and rear direction may be set to be at an angle of not more than 45° but not less than 15°. For example, the inclination angle “θ” is set to be about 30°. It is possible that the inclination angle “θ” of the inclined face 16g is set to be larger than 45°. However, in a case that the inclined face 16g is formed from the rear side face 16i of the terminal 16c to its front side face 16h, a protruding length of the terminal 16c from the terminal block 16b becomes very long, or a portion of the terminal 16c around which one end side of a conducting wire is wound and fixed becomes very short. Therefore, it is preferable that the inclination angle “θ” of the inclined face 16g is set to be at an angle in a range of 15° through 45°.

The front side face 16h of the terminal 16c is disposed on a rear side with respect to the front side face 16j of the terminal block 16b. Specifically, a distance “L” (see FIG. 2(B)) in the front and rear direction (center axis “CL” direction) between the front side face 16j, which is a side face on the winding part 16a side of the terminal block 16b, and the front side face 16h which is a side face on the winding part 16a side of the terminal 16c is set to be a half or less of a dimension in the axial direction of the center axis “CL” of the terminal 16c. Further, the rear side face 16i of the terminal 16c is disposed on the front side with respect to the rear side face 161 of the terminal block 16b, and outer side faces of the terminal 16c in the right and left direction are disposed on inner sides in the right and left direction with respect to the right and left side faces of the terminal block 16b. Further, the front side face 16j of the terminal block 16b is disposed on the same flat face as the front face of the flange part 16e.

One end side of a conducting wire structuring the drive coil 15 is wound around one of the two terminals 16c and the other end side of the conducting wire is wound around the other of the terminals 16c. Both end sides of the conducting wire are wound around the lower end sides of the terminals 16c. For example, each of both end sides of the conducting wire is wound around the terminal 16c from its lower end to an intermediate position in the upper and lower direction. The intermediate portion of the conducting wire is wound around the winding part 16a between the flange part 16d and the flange part 16e.

As described above, the bobbin 16 in this embodiment is formed by resin molding with the use of a die and thus a minute convex curved face (for example, a convex curved face whose radius of curvature is about 0.05 mm-0.1 mm) which is inevitably formed in a die working for resin molding is formed at a boundary between the inclined face 16g and the front side face 16h and at boundaries between outer side faces of the terminal 16c in the right and left direction and the inclined face 16g. On the other hand, a boundary between the inclined face 16g and the rear side face 16i is disposed on split faces of a die and a minute convex curved surface which is inevitably formed in a die working for resin molding is not formed at a boundary between the inclined face 16g and the rear side face 16i.

As shown in FIG. 1, a board 21 such as a flexible printed circuit board is fixed to the terminal block 16b for supplying an electric current to the drive coil 15 in the motor 1. The terminals 16c are inserted through holes which are formed in the board 21. Each of the both end sides of the conducting wire which are wound around the lower end sides of the terminals 16c is electrically connected with a pattern for power supply which is formed on the board 21 by the solder 22.

(Winding Procedure of Conducting Wire)

In the motor 1 structured as described above, a conducting wire is wound around the bobbin 16 in a state that the bobbin 16 is fixed to a rotation shaft of a coil winding machine. Specifically, first, in a state that the rotation shaft of the coil winding machine to which the bobbin 16 is fixed is stopped, one end side of a conducting wire is wound around one of the terminals 16c and fixed. After that, the rotation shaft of the coil winding machine is rotated and thus the bobbin 16 is rotated and, as a result, the conducting wire is wound around between the flange part 16d and the flange part 16e of the winding part 16a. After that, the other end side of the conducting wire is wound around the other of the terminals 16c and fixed and then, the wire beyond the fixed conducting wire is cut off and the winding work of the conducting wire around the bobbin 16 is finished.

### Principal Effects in this Embodiment

As described above, in this embodiment, the tip end of the terminal 16c is formed with the inclined face 16g which is inclined in the lower direction from the rear side of the terminal 16 (rear side face 16i) toward the front side (front side face 16h), and the tip end of the terminal 16c is structured of only the inclined face 16g. In other words, in this embodiment, the tip end of the terminal 16c is formed with the inclined face 16g which is inclined in the lower direction toward the front side, i.e., toward the winding part 16a side, but an inclined face which is inclined in the lower direction toward the rear side is not formed.

Therefore, the size of the bobbin 16 in the front and rear direction can be reduced and a distance “L” (see FIG. 2(B)) between the winding part 16a and the terminal 16c in the front and rear direction (center axis “CL” direction) is shortened. More specifically, the distance “L” in the front and rear direction between the portion of the winding part 16a around which a conducting wire is wound and the terminal 16c can be shortened and, as a result, even when the conducting wire is abutted with the tip end of the terminal 16c at the time of winding of the conducting wire around the winding part 16a, the conducting wire slips along the inclined face 16g to be easily slid down toward the winding part 16a. Therefore, in this embodiment, even when the size in the center axis “CL” direction of the bobbin 16 is reduced, the conducting wire is prevented from being caught by the terminal 16c at the time of winding of the conducting wire.

(Modified Examples of Terminal)

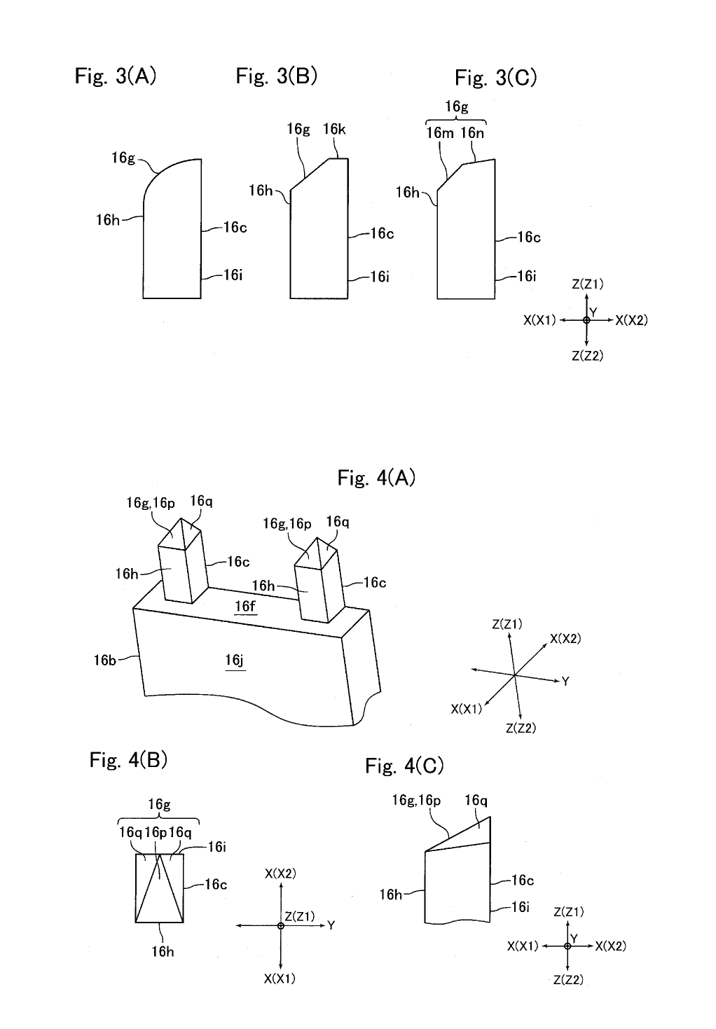

FIGS. 3(A), 3(B) and 3(C) are explanatory side views showing shapes of terminals 16c in accordance with other embodiments of the present invention. FIGS. 4(A), 4(B) and 4(C) are explanatory views showing a shape of a terminal 16c in accordance with another embodiment of the present invention. FIG. 4(A) is its perspective view, FIG. 4(B) is its plan view, and FIG. 4(C) is its side view.

In the embodiment described above, the inclined face 16g is formed in a flat face. However, the present invention is not limited to this embodiment. For example, as shown in FIG. 3(A), the inclined face 16g may be formed in a curved face. Specifically, the inclined face 16g may be formed in a convex curved shape. Even when the inclined face 16g is formed in a curved face, the inclined face 16g is inclined in the lower direction toward the front side. In a case that the inclined face 16g is formed in a flat face, the inclined face 16g is formed easily in comparison with a case that the inclined face 16g is formed in a curved face.

In the embodiment described above, the tip end of the terminal 16c is structured of only the inclined face 16g which is inclined with respect to the front and rear direction. However, the present invention is not limited to this embodiment. For example, in a case that a position of a conducting wire is not displaced to a rear side with respect to a half of the terminal 16c in the center axis “CL” direction when a conducting wire is wound around the winding part 16a, as shown in FIG. 3(B), it may be structured that the rear side of the tip end of the terminal 16c is formed in a parallel face 16k which is substantially parallel to the “XY” plane and the front side of the tip end of the terminal 16c is formed in the inclined face 16g which is inclined with respect to the front and rear direction. In this case, the inclined face 16g structures a front side portion of an upper side face structuring the tip end of the terminal 16c and the parallel face 16k structures a rear side portion of the upper side face of the terminal 16c. Further, in this case, it is preferable that a length in the center axis “CL” direction of the parallel face 16k is set to be not more than about ⅓ of a width in the center axis “CL” direction of the terminal 16c.

In a case that the tip end of the terminal 16c is structured of only the inclined face 16g, when a conducting wire is abutted with the tip end of the terminal 16c at the time of winding of the conducting wire around the winding part 16a, the conducting wire is always abutted with the inclined face 16g. Therefore, in a case that the tip end of the terminal 16c is structured of only the inclined face 16g, the terminal 16c can be disposed at a further near position with respect to the winding part 16a in comparison with a case that the tip end of the terminal 16c is structured of the parallel face 16k and the inclined face 16g. Further, in this case, even when the conducting wire is abutted with the tip end of the terminal 16c at the time of winding of the conducting wire around the winding part 16a, the conducting wire is further easily slid down to the winding part 16a along the inclined face 16g.

Further, the inclined face 16g may be structured of a plurality of inclined faces whose inclination angles are different from each other. For example, as shown in FIG. 3(C), the inclined face 16g may be structured of a first inclined face 16m and a second inclined face 16n which are inclined in the lower direction toward the front side and whose inclination angles are different from each other. In this case, the first inclined face 16m may be formed in a flat face or may be formed in a curved face. Further, the second inclined face 16n may be formed in a flat face or may be formed in a curved face.

Further, as shown in FIGS. 4(A), 4(B) and 4(C), the inclined face 16g may be structured of three inclined faces 16p and 16q which are formed so that both end sides in the right and left direction of the inclined face formed similarly to the inclined face 16g in the above-mentioned embodiment are chamfered. In this case, the inclined face 16q is disposed on each of both right and left sides of the inclined face 16p which is formed in a flat face and whose shape when viewed from an upper side is an isosceles triangle. The inclined face 16p is inclined in the lower direction toward the front side and the inclined faces 16q are inclined in the lower direction toward outer sides in the right and left direction. Also in this case, the tip end of the terminal 16c is formed with no inclined face which is inclined in the lower direction toward the rear side and thus, even when a conducting wire is abutted with the tip end of the terminal 16c at the time of winding of the conducting wire around the winding part 16a, the conducting wire is easily slid down toward the winding part 16a.

In the example shown in FIGS. 4(A), 4(B) and 4(C), the inclined face 16g is structured of three inclined faces 16p and 16q which are formed by chamfering both end sides in the right and left direction on the rear end side of the inclined face that is formed similarly to the inclined face 16g in the above-mentioned embodiment. However, the inclined face 16g may be structured of three inclined faces which are formed by chamfering both end sides in the right and left direction on the front end side of the inclined face that is formed similarly to the inclined face 16g in the above-mentioned embodiment.

As shown in FIGS. 2(A) through 4(C), in a case that the inclined face 16g is inclined so that a conducting wire abutted with the tip end of the terminal 16c at the time of winding of the conducting wire around the winding part 16a is slid down only toward the winding part 16a, even when the bobbin 16 is made thinner, in other words, even when a thickness in the center axis “CL” direction of the terminal block 16b is made thin and, as a result, the terminal 16c is disposed in the vicinity of the winding part 16a, a conducting wire is prevented from being caught by the terminal 16c at the time of winding of the conducting wire.

(Modified Examples of Terminal Block)

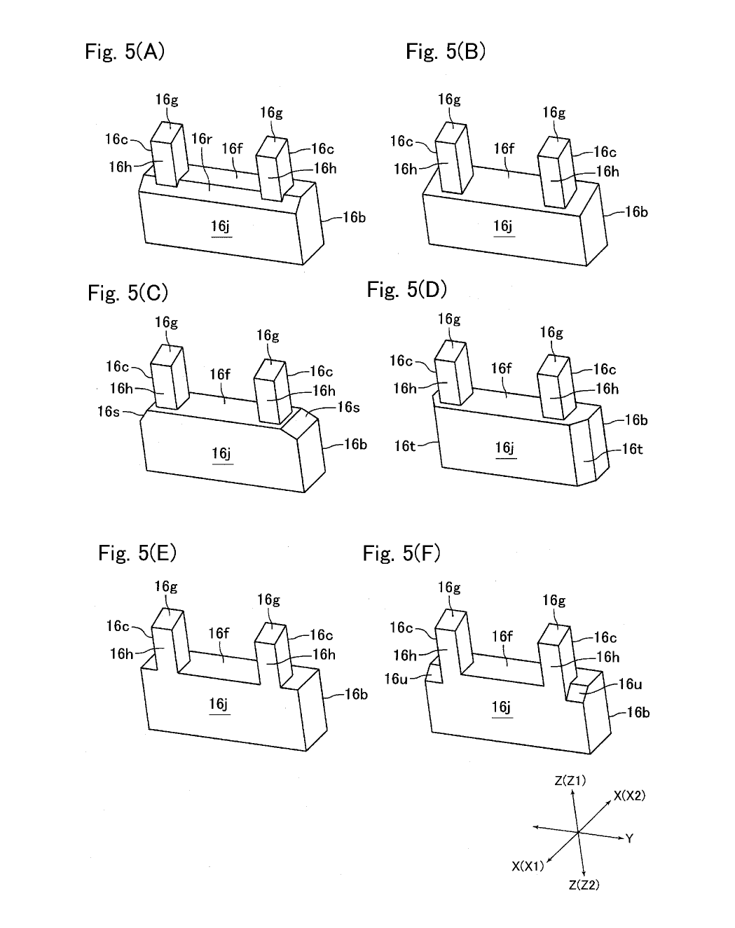

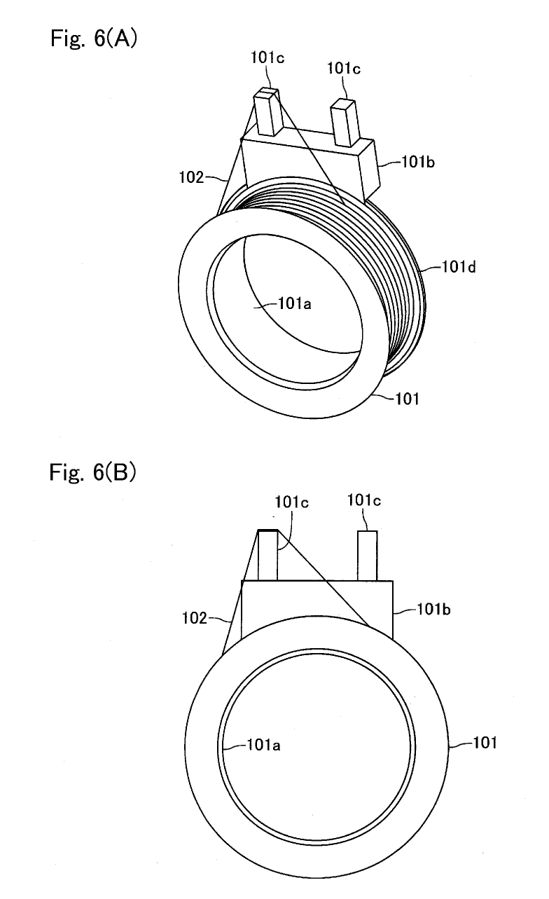

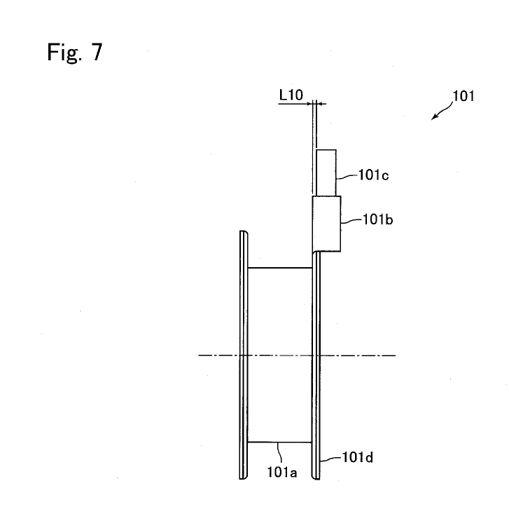

FIG. 5(A) through 5(F) are explanatory perspective views showing shapes of terminal blocks 16b in accordance with other embodiments of the present invention.

In the embodiment described above, the upper side face 16f of the terminal block 16b and its front side face 16j are perpendicularly connected with each other. However, the present invention is not limited to this embodiment. For example, as shown in FIG. 5(A), an inclined face 16r being inclined in the lower direction toward the front direction may be formed at a boundary between the upper side face 16f and the front side face 16j of the terminal block 16b. When a conducting wire is to be wound around the winding part 16a, the conducting wire is most likely to be abutted with the boundary between the upper side face 16f and the front side face 16j. Therefore, according to this structure, the conducting wire is effectively prevented from being caught by the terminal block 16b at the time of winding of the conducting wire. Further, the conducting wire which is abutted with the inclined face 16g of the terminal 16c and is slid down along the inclined face 16g at the time of winding of the conducting wire around the winding part 16a is effectively prevented from being caught by the terminal block 16b. In this case, the inclined face 16r is formed so that a boundary line between the inclined face 16r and the upper side face 16f is set to be a rear side with respect to the front side face 16h of the terminal 16c.

In this case, the front side face 16j is a first side face which is disposed on a winding part 16a side and the upper side face 16f is a second side face where the base end of the terminal 16c is disposed. Further, the inclined face 16r is a terminal block side inclined face which is inclined so that a conducting wire abutted with the terminal block 16b at the time of winding of the conducting wire around the winding part 16a is slid down only toward the winding part 16a.

Further, as shown in FIG. 5(B), the upper side face 16f of the terminal block 16b may be formed in an inclined face which is inclined in the lower direction toward the front direction. According to this structure, even when a conducting wire is abutted with the upper side face 16f of the terminal block 16b at the time of winding of the conducting wire, the conducting wire is slid along the inclining upper side face 16f to be easily slid down to the winding part 16a. Therefore, the conducting wire is effectively prevented from being caught by the terminal block 16b at the time of winding of the conducting wire. In this case, the front side face 16j is a first side face which is disposed on the winding part 16a side. Further, the upper side face 16f is a second side face where the base ends of the terminals 16c are disposed, and the upper side face 16f is a terminal block side inclined face which is inclined so that a conducting wire abutted with the terminal block 16b is slid down only toward the winding part 16a at the time of winding of the conducting wire around the winding part 16a.

Further, as shown in FIG. 5(C), inclined faces 16s which are inclined in the lower direction toward outer sides in the right and left direction may be formed at boundary portions between the upper side face 16f of the terminal block 16b and both side faces in the right and left direction of the terminal block 16b. Further, as shown in FIG. 5(D), inclined faces 16t which are inclined in the rear direction toward outer sides in the right and left direction may be formed at boundary portions between the front side face 16j of the terminal block 16b and both side faces in the right and left direction of the terminal block 16b. Also in this case, it is preferable that the inclined face 16t is formed so that boundary lines between the inclined faces 16t and both side faces in the right and left direction of the terminal block 16b are set to be a rear side with respect to the front side face 16h of the terminal 16c. Also in these cases, when a conducting wire is abutted with the terminal block 16b at the time of winding of the conducting wire around the winding part 16a, the abutted conducting wire slips along the inclined faces 16s and the inclined face 16t to be easily slid down toward the winding part 16a. Therefore, the conducting wire is prevented from being caught by the terminal block 16b at the time of winding of the conducting wire.

In the example shown in FIG. 5(C), the inclined face 16s is a terminal block side inclined face which is inclined so that a conducting wire abutted with the terminal block 16b is slid down only toward the winding part 16a at the time of winding of the conducting wire around the winding part 16a. Further, in the example shown in FIG. 5(D), the inclined face 16t is a terminal block side inclined face which is inclined so that a conducting wire abutted with the terminal block 16b is slid down only toward the winding part 16a at the time of winding of the conducting wire around the winding part 16a.

In the embodiment described above, the front side face 16h of the terminal 16c is disposed on the rear side with respect to the front side face 16j of the terminal block 16b. However, the present invention is not limited to this embodiment. For example, as shown in FIG. 5(E), the front side face 16h of the terminal 16c and the front side face 16j of the terminal block 16b may be formed on the same face as each other. According to this structure, in comparison with a case that the front side face 16h is disposed on the rear side with respect to the front side face 16j, the size in the front and rear direction of the bobbin 16 is reduced. Further, a conducting wire is effectively prevented from being caught by the terminal block 16b at the time of winding of the conducting wire around the winding part 16a. In this case, the front side face 16j is a first side face which is disposed on the winding part 16a side and the front side face 16h is a third side face which is disposed on the winding part 16a side.

Further, in a case that the front side face 16h and the front side face 16j are formed on the same face as each other, as shown in FIG. 5(F), inclined faces 16u may be formed at boundaries between the upper side face 16f and the front side face 16j on outer sides in the right and left direction of the terminal block 16b so as to be inclined in the lower direction toward the front direction. In this case, when a conducting wire is abutted with the terminal block 16b at the time of winding of the conducting wire around the winding part 16a, the abutted conducting wire slips along the inclined face 16u to be easily slid down toward the winding part 16a. In this case, the inclined face 16u is a terminal block side inclined face which is inclined so that a conducting wire abutted with the terminal block 16b is slid down only toward the winding part 16a at the time of winding of the conducting wire around the winding part 16a.

In the embodiment described above, the upper side face 16f and the front side face 16j of the terminal block 16b are formed in a flat face. However, the present invention is not limited to this embodiment. For example, the upper side face 16f and/or the front side face 16j may be formed in a curved face or a wave surface shape.

### Other Embodiments

Although the present invention has been shown and described with reference to a specific embodiment, various changes and modifications will be apparent to those skilled in the art from the teachings herein.

In the embodiment described above, the terminals 16c are integrally formed with the winding part 16a and the terminal block 16b. However, the present invention is not limited to this embodiment. For example, the terminal 16c may be separately formed from the winding part 16a and the terminal block 16b and fixed to the terminal block 16b. Further, in this case, the terminal 16c may be formed of resin or metal. When the terminals 16c are integrally formed with the winding part 16a and the terminal block 16b, the terminals 16c are easily formed in comparison with a case that the terminals 16c are separately formed from the winding part 16a and the terminal block 16b. Further, for example, when the terminal 16c is made of metal and is formed by cutting work, a burr may be formed on the inclined face 16g and a conducting wire abutted with the tip end of the terminal 16c may be hard to slip down at the time of winding of the conducting wire around the winding part 16a. On the other hand, when the terminal 16c is formed by resin molding, occurrence of a burr on the inclined face 16g is restrained and thus the above-mentioned problem can be eliminated. Further, when the terminal 16c is formed by resin molding, a conducting wire easily slips along the inclined face 16g and thus damage and disconnection of the conducting wire is prevented. Further, in the embodiment described above, the terminal 16c is formed in a substantially rectangular prismatic shape whose cross-sectional shape perpendicular to a protruding direction of the terminal is a quadrangle but a terminal 16c having another polygonal shape or a cylindrical shape may be used. Also in these cases, when the inclined face 16g is formed at the tip end of the terminal 16c, even in a case that a conducting wire is abutted with the tip end of the terminal 16c at the time of winding of the conducting wire around the winding part 16a, the conducting wire is slid down to the winding part 16a along the inclined face 16g.

In the embodiment described above, two terminals 16c are formed on the bobbin 16 but three or more terminals 16c may be formed on the bobbin 16. Further, in the embodiment described above, two terminals 16c are provided in a substantially parallel to each other but two terminals 16c are not required to be parallel to each other.

In the embodiment described above, the winding part 16a is formed in a cylindrical tube shape with flanges which are the circular ring-shaped flange parts 16d and 16e. However, the present invention is not limited to this embodiment. For example, the winding part 16a may be formed in a polygonal tube shape such as a rectangular tube shape or a hexagonal tube shape with flanges. Further, the flange parts 16d and 16e may be formed in a polygonal ring shape such as a rectangular ring shape or a hexagonal ring shape.

In the embodiment described above, the terminal block 16b is formed in a flat rectangular solid shape but the terminal block 16b may be formed in a shape other than the flat rectangular solid shape. For example, the terminal block 16b may be formed with projected and recessed portions in the front and rear direction and the right and left direction like the terminal block disclosed in Japanese Patent Laid-Open No. 2004-147426.

In the embodiment described above, a minute convex curved face which is inevitably formed at the time of die working for resin molding is not formed at a boundary between the inclined face 16g and the rear side face 16i. However, the present invention is not limited to this embodiment. For example, a minute convex curved face which is inevitably formed at the time of die working for resin molding may be formed at a boundary between the inclined face 16g and the rear side face 16i. The convex curved face in this case is formed so that a conducting wire abutted with the convex curved face is slid down to the rear side, i.e., to an opposite side to the winding part 16a at the time of winding of the conducting wire around the winding part 16a. However, the convex curved face is not included in the “inclined face” in the present invention. In other words, an embodiment in which a minute convex curved face which is inevitably formed at the time of die working for resin molding is formed at a boundary between the inclined face 16g and the rear side face 16i is included in the technical scope of the present invention.

In the embodiment described above, the rotor 4 is provided with one drive magnet 3 but the number of the drive magnet 3 which is provided in the rotor 4 may be two or more. Further, in the embodiment described above, the stator 6 is structured of the first stator assembly 12 and the second stator assembly 13. However, the stator 6 may be structured of one stator assembly or three or more stator assemblies. Further, in the embodiment described above, the motor 1 is a stepping motor but the bobbin with a terminal in accordance with the present invention may be applied to a motor other than a stepping motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A bobbin with a terminal comprising:
a winding part having a tube shape around which a conducting wire is wound;
a terminal block which is formed on one end side in an axial direction of the winding part; and
a plurality of terminals which is protruded from the terminal block in a direction substantially perpendicular to the axial direction of the winding part;
wherein a tip end of the terminal is formed with an inclined face which is inclined with respect to the axial direction of the winding part; and
wherein the inclined face is inclined so that the conducting wire abutted with the tip end of the terminal is slid down only toward the winding part when the conducting wire is to be wound around the winding part.

2. The bobbin with a terminal according to claim 1, wherein the inclined face is inclined so as to approach the winding part toward an other end side in the axial direction of the winding part.

3. The bobbin with a terminal according to claim 1, wherein the tip end of the terminal is structured of only the inclined face.

4. The bobbin with a terminal according to claim 1, wherein the inclined face is formed in a flat shape.

5. The bobbin with a terminal according to claim 1, wherein an inclination angle of the inclined face is set to be an angle of not more than 45° with respect to the axial direction of the winding part.

6. The bobbin with a terminal according to claim 1, wherein
circular ring-shaped flange parts are formed at both ends in the axial direction of the winding part,
the terminal block is formed in a rectangular solid shape which is flat in the axial direction, and
the terminal block is integrally formed with the flange part on an outer peripheral end of the flange part.

7. The bobbin with a terminal according to claim 1, wherein a cross-sectional shape of the terminal in a direction perpendicular to a protruding direction of the terminal is a substantially rectangular shape.

8. The bobbin with a terminal according to claim 1, wherein a distance between a side face of the terminal on an opposite side to the winding part and a side face of the terminal block on an opposite side to the winding part is set to be a half or less of a dimension in the axial direction of the terminal.

9. The bobbin with a terminal according to claim 1, wherein the inclined face is formed in a curved face.

10. The bobbin with a terminal according to claim 1, wherein a cross-sectional shape of the terminal in a direction perpendicular to a protruding direction of the terminal is a polygonal shape or a circular shape.

11. The bobbin with a terminal according to claim 1, wherein a distance between a side face on a winding part side of the terminal and a side face on a winding part side of the terminal block is set to be a half or less of a dimension of the terminal in the axial direction of the winding part.

12. The bobbin with a terminal according to claim 11, wherein a totaled dimension of the terminal block which is protruded to both sides with respect to the terminal in the axial direction of the winding part is set to be not more than a dimension of the terminal in the axial direction of the winding part.

13. The bobbin with a terminal according to claim 1, wherein the terminal is formed of resin.

14. The bobbin with a terminal according to claim 13, wherein the winding part, circular ring-shaped flange parts which are formed at both ends in the axial direction of the winding part, the terminal block which is formed on one end side in the axial direction of the flange part, and the plurality of the terminals which are protruded from the terminal block are integrally formed with each other by resin molding.

15. The bobbin with a terminal according to claim 1, wherein the terminal block is formed with a terminal block side inclined face which is inclined so that the conducting wire abutted with the terminal block is slid down only toward the winding part when the conducting wire is to be wound around the winding part.

16. The bobbin with a terminal according to claim 15, wherein
the terminal block is provided with a first side face which is disposed on a winding part side and a second side face on which a base end of the terminal is disposed,
the terminal block side inclined face is formed at a boundary between the first side face and the second side face, and
the terminal block side inclined face is inclined with respect to the axial direction of the winding part so as to approach the winding part toward an other end side in the axial direction of the winding part.

17. The bobbin with a terminal according to claim 16, wherein a boundary line between the terminal block side inclined face and the second side face is located on an opposite side to the winding part with respect to a side face on a winding part side of the terminal.

18. The bobbin with a terminal according to claim 15, wherein
the terminal block is provided with a first side face which is disposed on a winding part side and a second side face on which a base end of the terminal is disposed, and
the second side face is structured of the terminal block side inclined face and is inclined with respect to the axial direction of the winding part so as to approach the winding part toward an other end side in the axial direction of the winding part.

19. The bobbin with a terminal according to claim 1, wherein
the terminal block is provided with a first side face in a flat face which is disposed on a winding part side,
the terminal is provided with a third side face in a flat face which is disposed on the winding part side, and
the first side face and the third side face are disposed on a same flat face as each other.

20. A motor comprising:
a bobbin with a terminal comprising:
a winding part having a tube shape around which a conducting wire is wound;
a terminal block which is formed on one end side in an axial direction of the winding part; and
a plurality of terminals which is protruded from the terminal block in a direction substantially perpendicular to the axial direction of the winding part;
a drive coil which is structured of the conducting wire that is wound around the winding part; and
a drive magnet which is disposed on an inner peripheral side of the bobbin;
wherein a tip end of the terminal is formed with an inclined face which is inclined with respect to the axial direction of the winding part; and
wherein the inclined face is inclined so that the conducting wire abutted with the tip end of the terminal is slid down only toward the winding part when the conducting wire is to be wound around the winding part.

21. The motor according to claim 20, wherein the inclined face is inclined so as to approach the winding part toward an other end side in the axial direction of the winding part.

22. The motor according to claim 20, wherein the tip end of the terminal is structured of only the inclined face.

23. The motor according to claim 20, wherein a distance between a side face on a winding part side of the terminal and a side face on a winding part side of the terminal block is set to be a half or less of a dimension of the terminal in the axial direction of the winding part.

24. The motor according to claim 23, wherein a totaled dimension of the terminal block which is protruded to both sides with respect to the terminal in the axial direction of the winding part is set to be not more than a dimension of the terminal in the axial direction of the winding part.

25. The motor according to claim 20, wherein the winding part, circular ring-shaped flange parts which are formed at both ends in the axial direction of the winding part, the terminal block which is formed on one end side in the axial direction of the flange part, and the plurality of the terminals which are protruded from the terminal block are integrally formed with each other by resin molding.
